(19) United States
(12) Patent Application Publication
(10) Pub. No.: US 2013/0132318 A1
(43) Pub. Date: May 23, 2013

(54) Methods and Systems for Collaborative Formulation and Solution of Problems

(71) Applicants: Steven Tanimoto, Seattle, WA (US); Sandra B. Fan, Seattle, WA (US); Richard E. Rice, Seattle, WA (US); Robert Thompson, Seattle, WA (US); Tyler Robison, Seattle, WA (US)

(72) Inventors: Steven Tanimoto, Seattle, WA (US); Sandra B. Fan, Seattle, WA (US); Richard E. Rice, Seattle, WA (US); Robert Thompson, Seattle, WA (US); Tyler Robison, Seattle, WA (US)

(21) Appl. No.: 13/679,477

(22) Filed: Nov. 16, 2012

Related U.S. Application Data
(60) Provisional application No. 61/561,189, filed on Nov. 17, 2011.

(51) Int. Cl. G06N 5/02

(52) U.S. Cl. CPC G06N 5/02
USPC 706/46

(57) ABSTRACT

Methods and systems for computationally solving problems are disclosed. A problem can be specified using a computing device. The problem can include at least an initial state and a plurality of operators. Each operator of the plurality of operators can be configured to transform an input state to an output state. The computing device can set a current state of the problem to the initial state. The computing device can generate a display of at least the current state and at least one operator of the plurality of operators. The computing device can receive an input specifying a first operator of the plurality of operators. After receiving the input, the computing device can use the first operator to transform the current state to a transformed state. The computing device can store the transformed state.

### CROSS-REFERENCE TO RELATED APPLICATIONS

The present application claims priority to U.S. Provisional Patent Application No. 61/561,189, entitled “Methods and Systems for Collaborative Formulation and Solution of Problems” filed Nov. 17, 2011, which is entirely incorporated by reference herein for all purposes.

### STATEMENT OF GOVERNMENT RIGHTS

This invention is supported in part by Grant No. 0613550, awarded by the National Science Foundation. The United States Government has certain rights in the invention

### BACKGROUND OF THE INVENTION

Unless otherwise indicated herein, the materials described in this section are not prior art to the claims in this application and are not admitted to be prior art by inclusion in this section.

Problem solving is a kind of activity that occurs ubiquitously in human life, and which is essential to the well-being of societies as well as individuals. Problems range from what to make for dinner and how to get from home to the store to how to achieve world peace or eliminate poverty. Problems range through a spectrum of well-defined (e.g., winning a game of Tic-Tac-Toe or Checkers) to very complex (e.g., reducing global warming).

Problem solving technologies can be classified into four categories: state-space methods, constraint-based methods, simulation environments, and human process scaffolding and/or hosting. State-space methods were at the heart of early efforts in artificial intelligence, having been used in the General Problem Solver (GPS). GPS was designed and implemented by A. Newell, H. Simon, and their associates in the late 1950s. The GPS program implemented a search algorithm that would try to automatically find the solution to a problem by transforming an initial state in a step-by-step manner. While the GPS used a general approach, it relied on a simplistic algorithm for its solving activity, and it did not provide support for humans to direct the solving process.

Constraint-based methods build upon state-space methods by adding “constraints” to problem representations. A constraint is a restriction to which states or their components can conform in order to be legal or to be a candidate solution. Simulation environments provide special facilities for testing candidate solutions to problems, such as testing proposed mechanical structures for stability or determining whether a proposed urban transportation plan will lead to decreased air pollution. Human process scaffolding or hosting systems facilitate problem solving by enforcing protocols and workflows, and by providing shared access to needed materials and objects in intermediate stages of creation. For example, by modeling creative problem solving in terms of workflow, one can consider technological supports for that workflow.

Computer-supported cooperative work (CSCW) encompasses technology and work practices with the aim of improving one or more of the following: the quality of work performed, the time or cost efficiency with which work can be performed, accountability, security, educational aspects, quantity, and satisfaction. Typical technologies include software for communication, workflow management, group membership management, role assignment, archiving, and enhancement of individual awareness of others' activities.

Problem solving and CSCW have come together so that computers and communications technologies can contribute to problem solving. Indeed, most software applications are designed to solve some type of problem, such as managing bank accounts or helping an auto-body designer express a complex three-dimensional surface.

Many aspects of modern life discourage people from solving problems themselves: the complexity and closed-box designs of automobiles and computer chips, pose a psychological barrier to those who might want to take their systems apart and tinker. Companies and professionals advertise services and products with the suggestion that it is too difficult to do one's own repairs, auto maintenance, cook a meal from scratch, or select a remedy for a common cold. Complex problems such as global warming seem even more daunting, and it takes particular courage or optimism to get involved in serious attempts to address them. Many people would rather watch television, or read the news online, than make what they perceive to be a heavy mental effort to solve a significant problem.

There are a few software applications that are designed to help people solve any kind of problem; these typically provide tools for sketching and rearranging virtual note cards in a virtual workspace. Systems for crowdsourcing solutions to one kind of problem, such protein folding, have also been created.

### SUMMARY

In one aspect, a system is provided. The system includes a problem-formulation form, a plurality of operator forms, a processor, and a non-transitory computer readable medium. The problem-formulation form includes an initial-state input field for specifying at least an initial state of a formulated problem. Each of the plurality of operator forms includes an operator precondition field for specifying zero or more operator preconditions and an operator state-transformation function for specifying a transformation between states in the formulated problem. The non-transitory computer readable medium is configured to store instructions that, when the instructions are executed by the processor, cause the system to perform operations. The operations include: (a) generating a display including a display of the current state and a display of at least one operator, the at least one operator specified using the plurality of operator forms, (b) concurrently receiving a plurality of inputs, each input of the plurality of inputs identifying an operator that is specified using the plurality of operator forms, and (c) for each received input of the plurality of inputs: setting a current state of the formulated problem to a predetermined state, transforming the current state of the formulated problem to a transformed state of the formulated problem using the operator specified in the received input, and storing the transformed state.

In another aspect, a system for problem-formulation is provided. The system includes: a persistent non-transitory computer readable medium, a graphical interface, and a means for processing a form. The graphical interface is configured for simultaneously accepting inputs from a plurality of entities, each input for graphically specifying at least (a) an initial state of a problem and (b) at least one operator configured to transform a first state of the problem to a second state of the problem, where graphically specifying the at least one operator comprises use of direct graphical manipulation related to the at least one operator. The means for processing includes a means of storing the problem formulation in the persistent non-transitory computer readable medium for use in subsequent problem-solving activities.

In even another aspect, a system for problem solving is provided. The system includes: (a) means for creating an instance of a problem, where the problem is formulated as a structure including (i) a specification for creating an initial state and (ii) a specification for each of a plurality of operators, (b) means for realizing the initial state of the problem using the specification for creating the initial state, and (c) means for applying an operator of the plurality of operators to the initial state during a problem-solving session, where the problem-solving session can be accessed by a plurality of entities concurrently

In still another aspect, a system for computational problem solving is provided. The system includes: (a) means for specifying a problem solving task within a problem-solving session as a tree of states, where the problem solving task is a sub-problem of and/or information processing within a problem being addressed during the problem-solving session, where the problem solving task includes a task-focus state, and wherein the tree of states can be concurrently accessed by each entity of a plurality of entities, and (b) means for performing the problem solving task including at least one means selected from the group consisting of: (i) means for generating the tree of states by applying one or more operators to the task-focus state and/or at least one state generated by applying the one or more operators, and (ii) means for evaluating each state in the tree of states using a computational function during the problem-solving session.

In yet another aspect, a system is provided. The system includes a processor and a non-transitory computer storage medium. The non-transitory computer storage medium is configured to store at least: a first problem formulation, data for a solving session for solving the first problem formulation, and program instructions. The program instructions, upon execution by the processor, cause the system to perform operations. The operations include: enabling each entity of a plurality of entities to: retrieve the data for the solving session, obtain a first record of problem solving from the data for the first solving session, determine a second problem formulation, and generate a second record of problem solving associated with the entity for the second problem formulation based on the first record of problem solving.

In a further aspect, a method is provided. A computing device is used to specify a problem. The problem includes at least an initial state and a plurality of operators, where each operator of the plurality of operators is configured to transform an input state to an output state. The computing device sets a current state of the problem to the initial state. The computing device generates a display of at least the current state and at least one operator of the plurality of operators. The computing device concurrently receives a plurality of inputs. Each input of the plurality of inputs identifying an operator specified using the plurality of operator forms. The computing device, for each received input of the plurality of inputs: sets a current state of the formulated problem to a predetermined state, transforms the current state of the formulated problem to a transformed state of the formulated problem using the operator specified in the received input, and stores the transformed state.

In another further aspect, an article of manufacture is provided. The article of manufacture includes a computer-readable storage medium having stored thereon program instructions that, upon execution by a computing device, cause the computing device to perform operations The operations include: (a) specifying a problem, where the problem includes at least an initial state and a plurality of operators, and where each operator of the plurality of operators is configured to transform an input state to an output state, (b) setting a current state of the problem to the initial state, (c) concurrently receiving a plurality of inputs, each input of the plurality of inputs identifying an operator specified using the plurality of operator forms, and (d) for each received input of the plurality of inputs: setting a current state of the formulated problem to a predetermined state, transforming the current state of the formulated problem to a transformed state of the formulated problem using the operator identified in the received input, and storing the transformed state.

### BRIEF DESCRIPTION OF THE DRAWINGS

FIG. 1 illustrates an overall structure of the CoSolve system.

FIG. 2 illustrates the CoSolve system solving a problem or class of problems.

FIG. 3 illustrates an example problem formulation form and an example operator form for the CoSolve system.

FIG. 4 illustrates an example solving session display.

FIG. 5 is a block diagram of an example computing network.

FIG. 6A is a block diagram of an example computing device.

FIG. 6B depicts an example cloud-based server system.

FIG. 7 is a flow chart of an example method.

### DETAILED DESCRIPTION

The many complex problems facing modern civilization include addressing society-wide goals of controlling and stopping global warming, improving health care, and raising the quality of science education. Such society-wide goals not only touch upon the lives of many, but require the talents of many for their solutions. Problem solving systems that can integrate the contributions of large numbers of individuals are not only necessary for the actual solution of such problems but instrumental as well in mobilizing and energizing the participants to contribute.

Solving problems using communities of people, instead of solitary persons working toward solutions, can provide social, as well as problem-solving benefits. Solitary solving activities can become difficult, subject to dead ends, and largely devoid of communication experiences. Community solving with the aid of computers can become easier as members become adept at using computer tools. Further, when members both collaborate and have friendly competitions, computer-aided problem solving can become game-like and fun for the community members, as well as fostering communication skills. Dead-ends can be attacked by the knowledge and experiences of the entire community, possibly leading to solutions unavailable to single solvers.

To overcome the above-described limitations, in addition to other benefits, a computer system called “CoSolve” is presented herein that supports web-based collaborative formulation or “posing” and solution of problems. The problems do not have to belong to just one domain (such as protein-folding) but can come from any field involving or potentially involving information processing. These include the sciences and mathematics, music, art, design, writing, business management, medicine, and law. CoSolve brings together many elements of CSCW, problem-solving, theory underlying GPS and subsequent systems, and new innovations of its own.

CoSolve is web-based and permits crowd-sourcing of both the formulation and solving phases of problem solving and design. It includes a number of features that enable collaborative problem formulation and solving. One kind of crowd-sourcing is a social approach to problem solving in which computers are not used so much for solving the problems as for facilitating the matchmaking between those offering problems and those providing solutions.

Indicators for user awareness of others have been tested in a variety of online collaboration settings. Webcams and images of teammates, icons next to file listings, highlights and other ways to indicate the activities of other members of a team are valuable in helping individuals understand at the right level of detail what else is going on in the group. Users themselves are most often in the best position to decide how much awareness is helpful rather than a distraction.

Collaboration does not necessarily imply equal contributions or the same roles for all participants. By allowing different participants to have different options regarding shared objects (e.g., files), a group activity can be managed. Roles may be formal (defined within a system) or informal; for example leaders often emerge within a group, and leadership may be highly concentrated or distributed. A “role” can represent a particular set of permissions and responsibilities for a user, or it can represent a knowledge source, including a computer-provided entity. An “entity” can include one or more users and/or software that are capable of accessing and/or executing part or all of the CoSolve system.

For example, the entity can include a software agent, perhaps acting on behalf of a user. For example, a user can access an agent, configure the agent to perform activities for solving part or all of a problem (or access a suitably preconfigured agent), and then activate the agent to perform the problem solving activities. In one embodiment, the software agent can be directed to solve a “problem solving task” or sub-task of a problem by initially focusing on a “focus state” or initial state for the sub-task. The problem solving task can include solving the sub-task by generating states from the focus state until either (a) a specified “sub-task-goal state” is reached or (b) a maximum number of states, time to solve the sub-task, and/or depth of a sub-tree under the focus state has been reached.

The problem solving task can generate a state from the focus state by applying an operator applicable to a current state that depends on, or is the focus state. The current state can be initialized to the focus state and later can be a state generated from the focus state upon application of one or more operators on the focus state or state(s) generated from the focus state. The operators can be applied to a current state in a breadth-first fashion; e.g., apply all applicable operators to the current state to generate one or more sub-states of the current state, then change the current state to a sub-state of one or more sub-states. The operators can be applied in a depth-first fashion; e.g., apply an operator to the current state to generate a new state, label the new state as the current state; apply another or the same operator to the “new” current state to generate a second new state, and so on. Other techniques to generate new states as part of the problem solving task, such as evaluating each generated state to determine a score for the generated state and selecting a highest (or lowest) scoring state of the generated states as the current state for generating additional state(s) by applying operator(s) to the selected current state.

In some examples, a user can log in to a CoSolve system, access/configure the agent, and activate the agent to operate using the user's login credentials; e.g., a user name, a password, etc. associated with the user. Once the agent is activated, the user could log off and leave the agent to perform the problem solving activities alone. Many other uses and examples of software agents are possible as well.

The online communication tools important for collaboration online include: email, chat, annotation, bulletin boards, threaded discussion boards, voicemail, one-on-one and conference audio calls, video calls, meetings of avatars in virtual 3D environments, and shared visualizations. Shared visualizations and collaborative construction of these visualizations is one important mode of communication. However, communication, while essential to collaboration, does not fully exploit the computational capabilities of computers (with the possible exceptions of meetings in virtual environments, which is computationally demanding, and joint authoring, which uses the computer as a constructive tool).

### Introduction to CoSolve

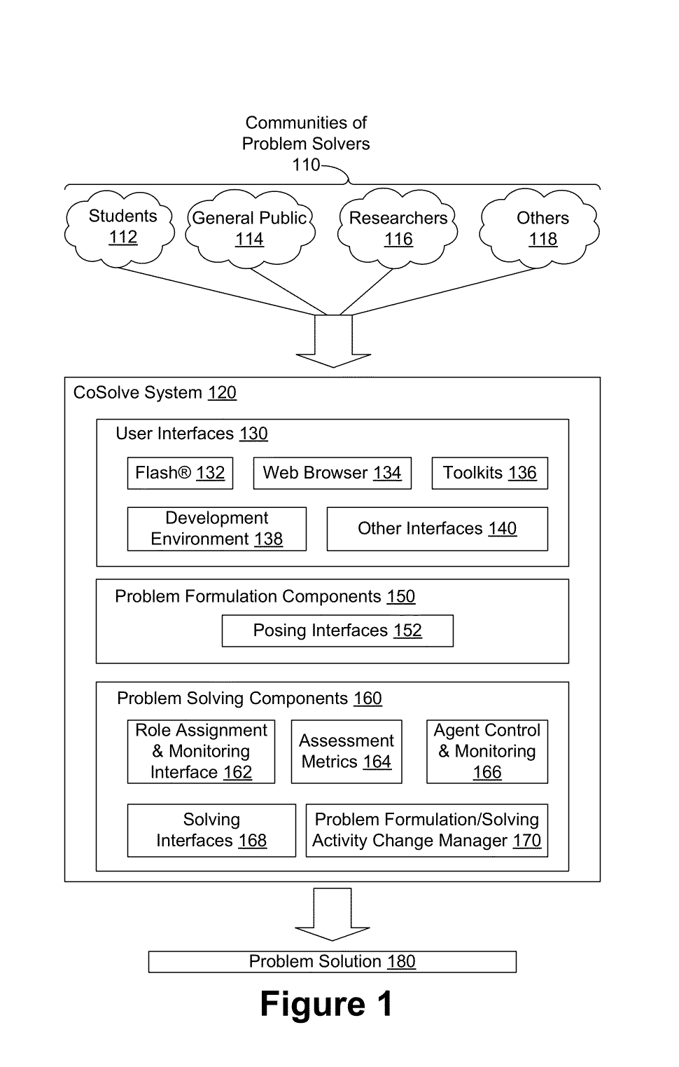

FIG. 1 illustrates an overall structure 100 of CoSolve system 120. CoSolve provides a solution where computation plays a bigger role (compared with matching of problem solvers to problem providers) including, in some cases, use of programs as shared objects in game or game-like environments where the computer simulates and enforces rules.

One aspect of problem solving in this framework is formulating the problems for this kind of treatment. Problem formulation, also referred to herein as “posing”, and solving problems are two phases of the same activity, separated somewhat arbitrarily as a formal matter, but both crucial in real problem solving, and in terms of building a culture of problem solving. Problem posing and solving are keys to socially intelligent computing, which can be a process performed by appropriately educated people when they solve problems collaboratively using active computational affordances. These people (a) understand what the technology does for them, (b) understand their technical roles in the solving process, and (c) understand their social roles in the solving process.

FIG. 1 shows various communities of problem solvers 110, including students 112, general public 114, researchers, and others (e.g., governmental agencies, private organizations, etc.), utilizing CoSolve system 120 to generate problem solution 180. CoSolve system 120 includes user interfaces 130, problem formulation interfaces 150, and problem solving components 170.

User interfaces 130 include components that permit user interaction with CoSolve system 120. The user interfaces include a Flash® interface 132 for displaying sequences of images, web browser 134 for web-based interaction, toolkits 136 to assist in posing problems and/or solving problems, development environment 138 for developing problem formulations, and other interfaces 140, such as, but not limited to, graphical user interfaces, network interfaces, still image displays, interfaces to tools and toolkits. Flash® is a registered trademark of Adobe Systems Incorporated of San Jose, Calif.

Problem formulation components 150 include posing interfaces 152 to permit novice and/or expert posers to readily formulate problems, perhaps in cooperation with development environment 138. Problem formulation can involve writing software that builds and supports various operations used during problem solving, describes states of the problem, and preconditions for utilizing operators, including role specification.

### Classical Theory of Problem Solving

The Classical Theory of Problem Solving describes transitions from a starting point to a problem solution through a systematic process. A problem is a sort of question for which someone may seek an answer. In general, a problem corresponds to a question of this form: “What arrangement of component objects will satisfy a set C of criteria?” As an example, a dinner menu selection planning problem could be expressed by the question, “What particular appetizer, main course, and dessert should be served for a dinner party of eight, given that one guest is a vegetarian and two others don't eat gluten, and that I don't want the preparation time to exceed two hours?”

A process to solve a problem can be thought of as a search through a space of possibilities to find a possibility that meets the criteria. Each possibility is called a “state”. In addition to the states that represent possibilities, states can also represent intermediate steps in the construction of possibilities. For example, a process to find an appropriate dinner menu could start with an “initial state” representing the situation where no decisions on any of the courses have yet been taken. To move from the initial state to a state in which some decision is taken, we should choose, for one of the three courses, a particular dish. For example, we might decide to choose hummus with carrots as the appetizer. Making such a choice is an example of “applying an operator”, where an operator is a scheme for going from one state to another state. In this case the operator is “choose hummus with carrots”. The state reached after applying this operator to the initial state is the state in which the appetizer has been chosen, the chosen appetizer is hummus with carrots, and neither the main course nor the dessert have yet been chosen. The operator “choose hummus with carrots” can only be applied to certain states - - - those in which an appetizer has not yet been chosen. This property, that makes the operator applicable to it, is called a “precondition” of the operator.

An operator whose preconditions are satisfied can use a “state transformation function”, which is a function whose domain is the set of states satisfying the precondition and whose range is the set of all the states for the problem. This set of all states for the problem is called the “state space” for the problem. Then, problem solving can amount to systematically searching the space. For this reason, the methodology is known by the name “state space search.” The essence of collaborative problem solving with the classical theory is to permit any member of a solving team to perform “design acts” or “problem-solving acts” which correspond to operations on an explicit state-space search tree.

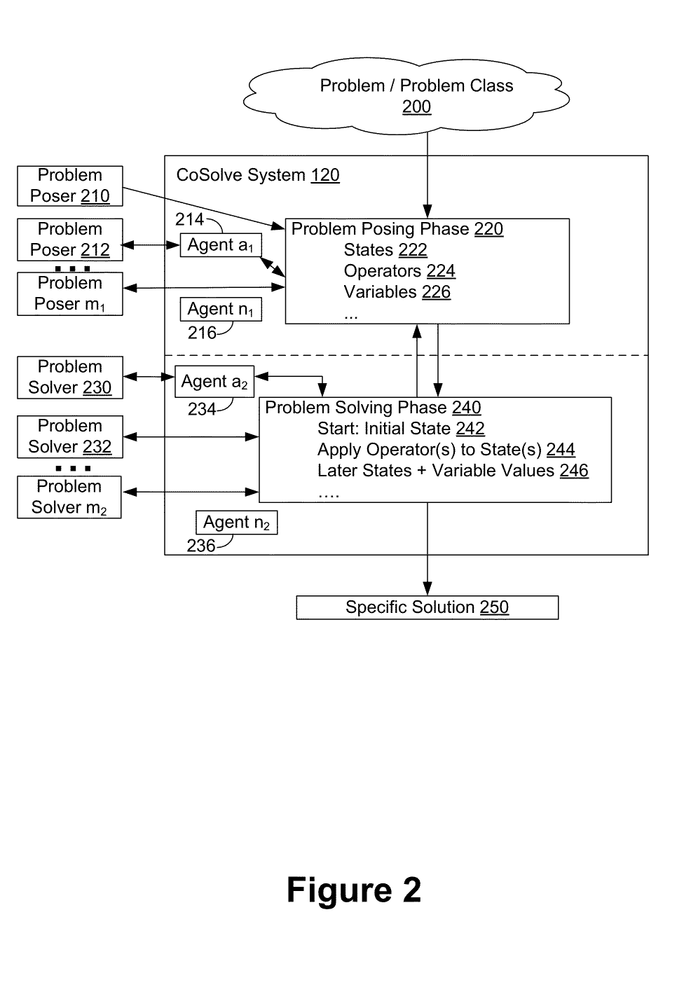

FIG. 2 shows CoSolve system 120 solving a problem or class of problems 200. The problem or class of problems 200 can be formulated by a number m1 of problem posers 210, 212, . . . m1 acting collaboratively to pose a problem during problem posing phase 220. Formulating the problem, which can meet the Classical Theory of Problem Solving's definition of a problem, can involve specifying states 222, operators 224, variables 226, and perhaps other software aspects that may or may not be directly related to the problem; e.g., graphic effects, sounds, etc.

FIG. 2 shows that poser 212 is utilizing software agent 214, which is one of a number n1 of poser software agents available, to aid formulation of the problem. For example, software agent 214 can copy and/or modify existing states and/or operations to speed problem formulation. As another example, software agent 214 can search through software libraries, previously-posed problems, and/or other sources for software and/or problem formulations (e.g., states, variables, and/or operations) that are the same or similar to those used in the problem being posed during phase 220. If software agent 214 generates search results, perhaps with the desired software, it can present part or all of the sought-after software and/or problem formulations to poser 212 for review and possible inclusion into the current problem.

CoSolve system 120 can also be used to annotate efforts and objects utilized during problem posing phase 220. For example, annotations can be, but are not limited to, uses to identify poser(s) to work on aspects of the problem, specify deadlines/scheduling information, provide comments and/or feedback on software and/or problem formulations, and explain how software and/or problem formulations are meant to be used during problem solving phase 230. In some cases, problem solvers 230, 232 . . . can provide annotations for problem posers during problem posing phase 220. For example, if problem solver 230 is asked to test a nearly-completely-posed problem; i.e., “beta test” the problem formulation, problem solver 230 may provide comments to problem posers in the form of annotations on states 222, operators 224, and/or variables 226.

In other cases, problem posers may provide annotations on problem solving phase 240, such as but not limited to information and/or explanations on how software and/or problem formulations are meant to be used during problem solving phase 230. In still other case, the roles of “problem poser” and “problem solver” can be constructed to limit or eliminate annotations; e.g., only entities (e.g., agents and/or users) with the role of “problem poser” can annotate problem posing phase 220 and only entities with the role of “problem solver” can annotate problem solving phase 240.

Once formulated, the problem or class of problems 200 can be solved by a number m2 of problem solvers 230, 232, . . . m2 acting collaboratively to solve problem or class of problems 200 during problem solving phase 240. CoSolve system 120 can enable one or more of the m2 problem solvers to solve a problem or class of problems concurrently; that is, multiple problems solvers can solve a problem or class of problems simultaneously. Solving the problem can involve applying operators 244 to transform a state of the problem, which can be initialized to an initial state 242, to generate later states and variable values 246. In some cases, a problem can be posed with one or more solution states; e.g., a desired arrangement of disks in the Towers of Hanoi problem; while other problems may not have specified solution state(s); e.g., a design for or a simulation of an organization's workflow may not have a specific solution.

FIG. 2 shows that solver 230 is utilizing software agent 234 which is one of a number n2 of solver software agents available, to aid solution of the problem. For example, software agent 234 can try several solutions based on rules provided by solver 230 to speed problem solving; e.g., a “move stack of disks” rule to speed solution of the Towers of Hanoi problem. As another example, software agent 214 can search through other problems and/or other sources for information applicable to solving the problem being solved during phase 240. If software agent 234 generates search results, it can present part or all of the sought-after information to poser 230 for review and possible use in solving the current problem.

### Problem Formulation in CoSolve

Posing is a creative process that can involve aspects of systems analysis, modeling, and game design, among others. It involves several aspects: identifying or creating the idea for a problem, modeling the features of candidate solutions (states) often in terms of components and their interrelations, design and implementation of operators, creation of visualizations, and debugging. In its most general form, it is a kind of programming, since the operators of a problem are typically expressed using program code.

Before a problem's states and operators can be defined, a set of background assumptions for a problem can be adopted by the stakeholders, and the basic features of the problem stated. CoSolve can support this posing process with a series of “meta-problem” templates that make the problem specification activity itself into a collaborative problem-solving activity that can be carried out with the collaborative affordances for solving already in the system.

CoSolve includes both a functional posers' interface and an advanced posing toolkit; e.g., one toolkit in toolkits 136, to facilitate the posing of more complex problems. The advanced posing toolkit can include an advanced posing tool, perhaps configured as a plug-in, that enables posers to work offline, to have the full power of a modern integrated development environment at their disposal, and to have specialized refactoring and wizard support relevant to posing. This plug-in can be accompanied by a posing library of subroutines that facilitate creating operators, handling such aspects as parameter validation, component addition, component selection, and reordering of components.

Refactoring operations provided by CoSolve may include operator splitting, merging, and composing state spaces using Cartesian products. Visualization methods for standard datatypes such as strings, lists, and hashes can facilitate rapid prototyping by posers. The posing library can include facilities that allow problem-solving sessions to make use of web services; for example, the posing library can include aspects of a system, such as the SAGE system, for computing state changes within operators for mathematical problem-solving]. The posing library can have bindings in several languages (e.g., C++, Java, Python) for a standard interface to facilitate the creation of CoSolve-compatible web services. This tool and library can aid posers to work collaboratively by commenting on their own and others' templates, and working collaboratively in traditional ways (in contrast to the new kind of collaboration we support in the solvers' phase, described later), with online file sharing, iterative design and testing, and discussion forums.

In some embodiments, the posing library can permit multiple entities to simultaneously access a problem-solving session. In particular embodiments, the posing library can generate a common display showing the contributions to a problem solution made by some or all of the multiple entities accessing the problem-solving session.

For novice posers, CoSolve can include an end-user programming system that lets non-programmers explore problem formulation in meaningful ways. Novices can specify operators using built-in primitives for adding components to states, reordering components, and expressing constraints that can hold in order for an operator to be applicable. Transparency in the interface can sometimes avoid some of the frustrating mysteries that novice programmers typically face). Posing with the novice interface can be an entry point into more realistic programming, as well as a way to educate users about the posing process.

By factoring a problem into subproblems, a team can use divide-and-conquer approaches to the solution of complex problems. More generally, there is a class of meta-solving problems based on the question “How can a solution S to problem P1 be applied usefully to another problem P2?” Given a set of methods for doing this, we can conceive of posing a complex problem as a process of posing more and more complex refinements of a problem in an iterative fashion. CoSolve permits tools within the problem posing and solving environment for organizing collections of related problems to facilitate such developments.

In order to facilitate the modularization of problem templates, these tools, perhaps configured as a software plug-in to a browser, can be accompanied by a library of subroutines that facilitate creating operators, handling such aspects as parameter validation, component addition, component selection, and reordering of components. Visualization methods for standard datatypes such as strings, lists, and hashes can facilitate rapid prototyping by posers.

At the same time, posers can be encouraged to work collaboratively by offering means to mark code with special annotations that link to discussions and feedback from solvers and other posers. At the same time, posers can use various more conventional forms of collaboration: commenting on their own and others' templates, and using online file sharing, following iterative design and testing protocols.

### Solving Problems Using CoSolve

Users who solve problems in CoSolve we call solvers. Solvers can start new solving sessions or participate in sessions that have already been started. In some embodiments, starting a session involves two steps: (a) selecting a problem template and instantiating it, and (b) defining a group or policy that controls who may take part in the session. Participating in a session, assuming it has already been started, comprises examining what has been done so far, communicating with other participants, and contributing new problem-solving steps to the session.

Although CoSolve uses the classical theory of problem solving, states are, by default, created directly by users applying operators to previous states. In one embodiment, CoSolve includes a website having an infrastructure implemented in PHP and MySQL. The course of problem solving in CoSolve proceeds in two phases: formulation (or “posing”) and solving. Posing is a process of problem analysis, structuring, and, in one embodiment, scaffolded programming with Python code fragments. Solving is a process of making moves in the space of possibilities defined by the problem formulation. Before describing the posing process in more detail, let's consider the solving phase.

CoSolve currently supports solvers with an interface and back-end functionality for both (a) session initiation and (b) contributing to a session, described above. Basic solver affordances include: interactive viewing of the session history, represented as a state-space search tree; current state selection; operator selection and application; and state annotation. These solving interfaces can be largely or completely transparent to the solvers. Transparent interfaces can permit end users to understand and access the context, inferences, decisions, assumptions, and internal data that provide a basis for decisions made by underlying intelligent processes.

CoSolve includes features that empower solvers and enable scaling up the complexity of problems that can be solved. One feature is the ability to share customized views of the session, with various tree nodes magnified, hidden, various annotations and highlights rendered in particular ways to support communicating about progress and strategy. Another feature includes an end-user mini-language for specifying tasks that can be farmed out to agents.

A simple example of such a task would be to search to a depth of 8 levels from a given node and report the 10 best scoring states found according to a given evaluation function (e.g., the expected number of calories per person in the dinner menu, or the cost of equipment in a new playground). Once a task such as this has been specified and launched by a solver, a display of progress and results is required, and chosen parts of the results can be integrated into the session's history tree.

As the number of solvers increases, problem solving sub-trees can be summarized mathematically and/or statistically and the summaries displayed via user interface 130 of CoSolve system 120. Such summaries can be integrated with annotations to facilitate highlighting of popular subproblems or approaches, or roadblock areas, for example.

As another example, consider the challenge faced by a group of scientists tasked with creating an ontology for cranio-facial development. An existing ontology, the Foundational Model of Anatomy (the FMA), is available for the adult human body. However FMA does not cover either the development process or animals such as mice, which are very important to some members of the cranio-facial research community. Specific problem templates can be used to build parts of a cranio-facial development ontology using a collaborative process in which computation can play a role in (a) continuous assessment of the completeness and consistency of an ontology (in relation to goals for it that have been entered), and (b) semiautomatic refinement of ontology versions based on CoSolve operators that embed specific algorithms for conflict resolution in sets of terms with competing definitions.

In a specific session, we might have a Team A studying mice, and a Team B studying humans. They all begin a session in which the root state holds the FMA ontology. Group members can then apply operators to this ontology to add new subject, each with a name, definition, perhaps images, and other features, and relationships to other subjects. Each move generates a new state of the ontology. In the collaboration, it many happen that Team A applies an operator to add a new subject E1, its name, descriptors, etc. Team B sees this subject, and believes it to be the same as the human subject E2. They then branch off by re-naming this subject E2 instead of E1. Throughout the entire tree, there will be various places where the tree has split into branches, due to divergent opinions.

Then, through the use of CoSolve communication tools, the whole group can find places where there are splits, discuss the differences, and come to a compromise, at which point the branches can then be merged. Here we can see CoSolve being used as a conversational tool. CoSolve could also be used in a computationally intelligent manner. Say the two teams did not realize E1 and E2 were the same, and had added them separately. CoSolve computational agents could traverse the tree and try to match entity descriptions that are the same, and submit them to human users and/or software agents for consideration.

### Roles in CoSolve

Solver roles can be used in scaling up socially intelligent problem-solving systems.

In the simplest collaboration scenarios, the various members of a team have the same privileges, status, and, at least as far as the system is concerned, the same responsibilities. As teams get larger, they get potentially more complex, in terms of social structures, diversity of skill sets, and other human attributes. Roles can be spoken of in both an informal sense and a formal sense. The formal sense of “role” is the sense of a named part that an individual can play in an online activity, with its own affordances (options and abilities), and responsibilities, known to the system, enabled and typically enforced by the system. The success of large problem-solving teams depends on people contributing, and formal roles can help people to know what is expected of them.

The need for roles arises from the complex demands of complex problems, the diversity of knowledge and skills that may be required, and the frequent need for social structure within a solving team. Models for systems of roles come from a variety of sources: business structures, sports teams, games, government structures, and other social structures of all kinds, including animal societies such as ant and bee social structures. Roles may be domain-independent (leader, builder, critic, etc.) or subject specific (water-drainage expert, fertilizer specialist, epidemiologist, etc.).

In order to help scale up both the complexity of problems solved in CoSolve and the number of users who can effectively contribute within a session, roles can be used in: (a) an end-user-programming system for specification of roles by posers, (b) a role-assignment policy control screen for session initiators, and (c) a role-selection option for other solvers.

For example, two roles, called “X” and “O”, can be used to regulate turn taking in a game of Tic-Tac-Toe. In another example, software for collaborative design of games can use a number of roles, such as “architect,” “image puzzle designer,” “music puzzle designer,” and “rule base designer”. Each role can correspond to a particular subset of the operators for a problem. The architect can only see and apply architects' operators, etc. In addition, state visualizations are specific to each role. By adding more sophisticated features for roles to CoSolve, problem solving groups can be better supported, as well as supporting exploration of the pros and cons of various kinds of roles in a solving number of different problems.

### Differences in Posing and Solving Problems

Posing requires analytical skill that permits someone to model a situation as a computational system. The solving activities, by contrast, have a game-like quality in which there are definite rules, and playing within the rules has tended to be an easier task than formulating the rules. Second, in some embodiments, posing requires programming in Python, and for security reasons, the posers have to be trusted by the administrators not to either intentionally create malicious programs or unintentionally create programs that adversely affect others. Thus, posers can (almost) be part of the development team. Third, posing has tended to be a solitary activity in the sense that the special collaborative affordances that CoSolve currently provides for solving cannot be used directly in the problem formulation process.

The CoSolve system is intended narrow the gap between posing and solving to enable a new kind of collective process of formulation and solving. Narrowing this gap can lead to better problem formulations, because some of the obstacles between posers and solvers are eliminated, thus allowing more and more timely feedback to posers who are working to improve their formulations. Another benefit is that solvers can learn to become posers more easily, leading to solvers playing more responsible roles themselves and with an additional depth of understanding of problem solving technology, and so becoming better solvers as well as posers. CoSolve also provides a test bed for learning which computational affordances and social policies on a website are most helpful in fostering real problem solving and in facilitating learning about problem solving.

CoSolve permits definition of computational agents, even by end users, that can be part of the toolkit for solving teams. Such a framework, together with technologies for graphical interfaces and multimodal online communication, enables better conception of problems and collaboration during the problem solving process.

### Fostering Engagement and a Culture of Problem Solving

One aim of the CoSolve project has been to promote consciousness raising among the worlds' citizenry about how to formulate and solve problems, and to give people a sense that they can solve some problems and contribute to the solutions of complex problems.

A web site for CoSolve can assist these global problem solving efforts by: (a) including compelling examples of solvable problems on the web site, (b) providing learning materials that help people get started and help people deepen their knowledge of problem solving, (c) providing affordances on the web site that help users form communities that go beyond simply the solving of a problem here and there, so that they are encouraged to tackle complex problems and share their results. The web site can provide links and suggestions that encourage groups to learn about and adopt state-of-the-art design methodologies that stress iterative refinement and user-community involvement.

User engagement with the web site can be examined to learn what factors best lead to serious engagement. The social issues include the following: common understanding of the process, propensity to contribute, and disruption. In particular, disruption can have types and measures of disruption and conditions that lead to disruption, e.g., a site may be hosting solutions of controversial problems, such as health care system design. The CoSolve web-site can use various approaches to protect a system from some forms of disruption, such as (1) separation of highly-charged problems onto another site, in which extra monitoring can be done and in which additional restrictions are in place, and (2) careful specification of roles, some of which have very limited posting privileges.

CoSolve can be used to study the social dynamics within communities of problem solvers. Sometimes, the nature of a problem may be used to predict the social dynamics of its solver groups. For example, problems with complex structure probably require leaders, whereas some problems are amenable to highly parallel but leaderless solution (e.g., finding supernovas in Hubble telescope imagery).

Social aspects of problem posing and solution can be examined and tools provided for these social aspects. For example, posers working within the same problem domain (e.g., global warming) might compete with one another, because the problem formulation that is most compelling to prospective solvers might end up monopolizing the attention of the solvers. On the other hand, they might work together to share insights, to evolve each other's formulations, and jointly pose complex problems. Example patterns of collaboration in posing are found in the following example poser comments: (a) “I'll modify your problem template by cloning it and adding 3 operators” (b) “Can you pose subproblem 1 and I'll pose subproblem 2?” Therefore, CoSolve can use tools for collaborative posing of problems and breaking down problems into subproblems in accordance with these social aspects.

CoSolve activities can be used by a variety of solving groups, including elementary and high school students working to pose and solve problems related to climate change. In particular, CoSolve can be configured to present a simulation game in which the goal is stop or slow global warming by controlling factors such as deforestation, and burning of fossil fuels. As another example solving group, undergraduates at a Native American college can use CoSolve to pose and solve problems related to climate change. However, concerns expressed by Native American undergraduates related to climate change can differ from the concerns of elementary and high school students. CoSolve can be configured to help explore design of policies for sustainability and to enable collaborative formulation and solution of complex problems in this domain, among others.

### Evaluation and Assessment

In order to benefit our understanding of collaborative problem solving in large groups, CoSolve includes assessment tools that help us assess performance at three levels: individual cognitive level, group level, and the system itself At the individual level, the software can maintain statistics of operations performed by each user, and in some cases, what a series of user actions implies about their knowledge of the system or in a particular subject area. At the group level, the system can enable annotation of session history trees with information about user contributions such as operations attempted, time spent, and the net evaluation scores from the group as a whole. At the system level, statistics can be generated and gathered related to all types of interaction with the site, including visiting, posing, session initiation, and participation in solving sessions. CoSolve can solicit feedback from users through comment areas and online questionnaires. Progress on posing and solving can be displayed not only in session history trees but on problem timelines, generated automatically from annotated history trees.

### Example CoSolve Forms and Solution Trees

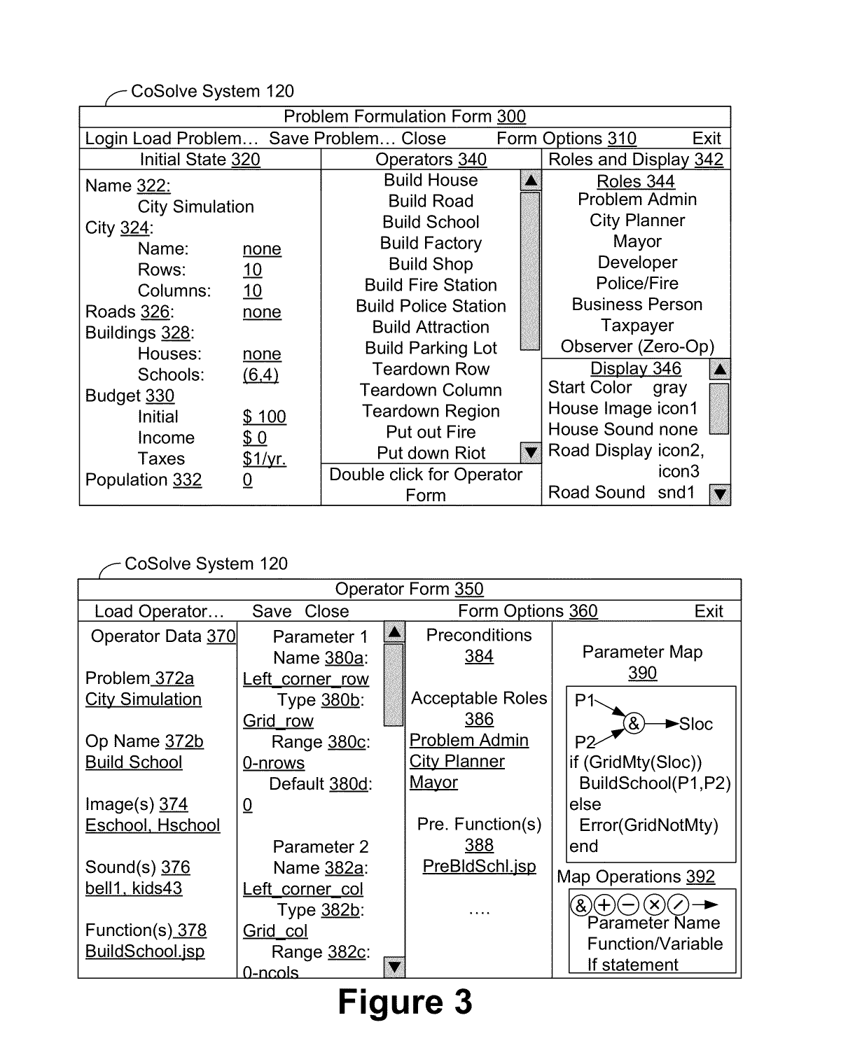

FIG. 3 illustrates example problem formulation form 300 and example operator form 350 for CoSolve system 120. FIG. 3 shows that problem formulation form 300 includes form options 310, initial state specification 320, operator specification 340, and roles and display specification 342.

Form options 310 can include options and operations for problem formulation form 300, including options/operations for logging in/logging out to/from the CoSolve system as a specific entity, loading a problem formulation, saving a problem formulation specified using problem formulation form 300, closing problem formulation form 300 without saving, and exiting problem formulation form 300 with the option to save or discard data on problem formulation form 300. Loading a problem formulation can include specifying a problem formulation to be loaded, e.g., using a dialog or other input interface for prompting for the name of the problem to be loaded, retrieving and loading the specified problem formulation into CoSolve system 120, and displaying the loaded problem formulation using problem formulation form 300. Saving a problem formulation specified using problem formulation form 300 can include specifying a name for the problem, e.g., using a dialog or other input interface for prompting for the name of the problem, and saving the problem under the specified name. Other form options are possible as well.

In some examples, options/operations related to problem solving phase files or other options can include providing criteria to identify a solver or poser to CoSolve system 120.

Initial state specification 320 can be used to specify an initial state for a problem. In the example shown in FIG. 3, the problem is related to simulating a city, and the initial state for the city simulation includes initial state information regarding the problem name 322, city 324, roads 326, buildings 328, budget 330, and population 332. In other examples, initial state specification 320 can include fewer, different, and/or more information as part of the initial state.

The problem name 322 can be used to identify the problem for use with the loading and saving operations discussed above in the context of the form options 310. When the problem associated with the “City Simulation” problem formulation is to be solved, the solver(s) can use problem name 322 to identify, locate, load, save, and operate a problem formulation for solving; e.g., use “City Simulation” for the problem formulated using example formulation form 300 shown in FIG. 3.

FIG. 3 shows that the initial state of city 324 can include information about the city's name, and display size in rows and columns. The example shown in FIG. 3 involves an initial state of a nameless city whose size is 10 rows by 10 columns. The initial state of roads 326 can include specification(s) for road(s) built as part of the initial state of the city; i.e., roads in place the time of city's founding. FIG. 3 shows that the initial state of roads 326 includes no roads. The initial state of buildings 328 can include specification(s) for building(s) built as part of the initial state of the city; i.e., buildings in place at the time of city's founding. FIG. 3 shows that the initial state of buildings 328 includes at least a school at location (6,4) in the 10×10 grid for the city. The initial state of budget 330 can include an initial amount of money and an income initially available to the city, and taxes initially due to be paid by the city. FIG. 3 shows that the initial state of budget 330 indicates that the city has $100 initially and $0 of initial income, and is initially assessed $1/yr. in taxes. The initial state of population 332 can include an initial number of people living in the city, shown in FIG. 3 as 0. In other examples, the initial states of city 324, roads 326, buildings 328, budget 330, and population 332 can include less, different, and/or more information as part of the initial state. In still other examples, a city can have less, different, and/or more information to specify initial state 320 than shown in FIG. 3.

Operator specification 340 can include operators to manipulate a state of a problem. In the example shown in FIG. 3, the operators shown include operators to build house(s), road(s), school(s), factories, shops, fire stations, police stations, attractions (e.g., stadiums, universities, museums, libraries), and parking lots in the city, operators to teardown rows, columns, and regions of the city, and operators to respond to city crises such as putting out a fire or putting down a riot. In other examples, less, different, and/or more operators can be used to transform states in a city simulation than shown in FIG. 3. At the bottom-center portion of form 300, an instruction to “Double click for Operator Form” is shown to indicate that once an operator is selected; e.g., the “Build School” operator, double clicking on the selected operator can instruct CoSolve system 120 to bring up operator form 350 for the selected operator. FIG. 3 also shows operators 340 with a scroll bar to indicate that more operators are available using problem formulation form 300.

Roles and specification 342 includes roles specification 344 and display specification 346. Roles specification 344 can be used to display and define roles to be followed while solving the city simulation problem utilizing CoSolve system 120. FIG. 3 show shows that roles specification 344 can include a problem administrator role, a city planner role, a mayor role, a developer role, a police/fire role, a business person role, a taxpayer role, and an observer role. In other examples, fewer, different, and/or more roles can be used in a city simulation than shown in FIG. 3.

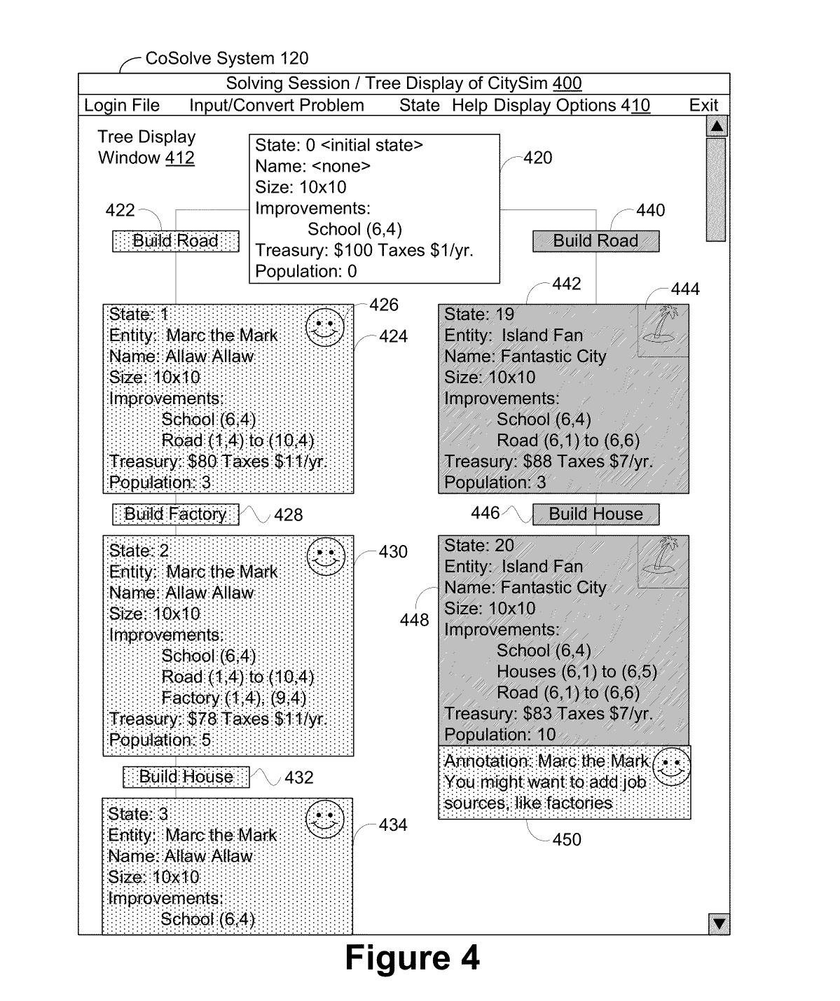

When so instructed, such as by double clicking on the name of a role in roles specification 344, CoSolve system 120 can display and manipulate additional information about a role using a form similar to operator form 350 (not shown in FIG. 3). The additional information about a role can include a list of operators that a role can or cannot use during the city simulation. For example, a problem administrator who can be asked to review and solve problems about the simulation may have access to any/all operators. As other examples, a city planner can have access to operators for building and tearing down city structures, but may not have access to operators for putting out fires or putting down a riot; while a police/fire role may have the opposite access (e.g., access to operators for putting out fires or putting down a riot, but no access to operators for building and tearing down city structures). In some cases, an observer or “zero-op” (for zero-operator) role can be created. The observer role can have access to review/read session histories, such as shown in FIG. 4, generate annotations, and comment on problem session histories, but has no access to operators that manipulate the state of the city simulation, such as other operators in operator specification 340.

Display specification 346 can include a starting color or colors for displaying/rendering the city during a city simulation, specifications for images and/or sounds associated with objects in the simulation, such as houses, roads, schools, factories, etc., and other information related to displaying and/or presenting information about the city simulation to problem solvers. In other examples, more, different, and/or less information can be provided as part of display specification 346 than shown in FIG. 3.

FIG. 3 shows operator form 350 with form options 360, operator data specification 370, parameter specifications 380a-380d, 382a-382d, precondition specifications 384, and a parameter map 390 with available map operations 392.

Operators can, but do not necessarily have to be associated with, problem formulations. For example, generic “clear screen” or “display that a solution was reached” operators can be provided by CoSolve system 120 without being associated with a specific problem formulation. To associate an operator with a problem formulation, the operator name can be added to operator specification 340 of problem formulation form 300.

Form options 360 can include options and operations for operator form 350, including options/operations for loading an operator, saving an operator specified using operator form 350, closing operator form 350 without saving, and exiting operator form 350 with the option to save or discard data on operator form 350, Loading an operator can include specifying a problem formulation and/or an operator to be loaded, e.g., using a dialog, operator form 350, or another input interface for prompting for the name of the operator to be loaded, retrieving and loading the specified operator into CoSolve system 120, and displaying the loaded operator using operator form 350. Saving an operator specified using operator form 350 can include specifying a name for the operator, e.g., using a dialog or other input interface for prompting for the name of the problem, and saving the problem under the specified name. Other form options 360 are possible as well.

As shown in FIG. 3, operator data specification 370 can include a problem name specification 372a, an operator name specification 372b, associated image(s) specification 374, associated sound(s) specification 376, and associated function(s) specification 378.

Problem name specification 372a and operator name specification 372b can be used to identify the operator being specified using operator form 350. In some examples, only operator name specification 372b need be specified to identify the operator. In other examples, if problem name specification 372a is provided to access an operator, then operator name specification 372b must be a name of an operator associated with the problem named as problem name specification 372a. For example, if problem name specification 372a is “City Simulation”, such as shown in FIG. 3, then operator name specification 372b must specify an operator listed in operator specification 340; e.g., for the example shown in FIG. 3, operator name specification 372b include one of “Build House”, “Build Road”, etc.

Associated image(s) specification 374 can be used to specify and associate images with the operator. For example, FIG. 3 shows that operator name 372b is “Build School”. Then, associated image(s) specification 374 can be names or other identifiers for locating images associated with the Build School operator, such as “Eschool” for a file storing an image of an elementary school and “Hschool” for a file storing an image of a high school. Other image specification examples, including specification of more, different, fewer, or no images to be associated with the operator, are possible as well.

Associated sound(s) specification 376 can be used to specify and associate sounds with the operator. Recall that operator name 372b is “Build School”. Then, associated sound(s) specification 376 can be names or other identifiers for locating sounds associated with the Build School operator, such as “bell1” for file storing a sound of a school bell and “kids43” for a file storing sounds of children at school. Other sound specification examples, including specification of more, different, fewer, or no sounds to be associated with the operator, are possible as well.

Associated function(s) specification 378 can be used to specify and associate software functionality with the operator. During the problem solution phases, when a solver chooses an operator to solve a formulated problem, CoSolve system 120 can use associated function(s) specification 378 to identify function(s) that carry out software operations for the chosen operator. For the “Build School” operator shown in FIG. 3, the “BuildSchool.jsp” file specified using associated function(s) specification 378 can include software configured to carry out software operations for simulating building of a school for the city simulation. The software operations can be coded in one or more computer languages, such as but not limited to, Java, Python, C++, C, and Perl. Other function specification examples, including specification of more, different, fewer, or no software to be associated with the operator, are possible as well.

Parameter specifications 380a-380d, 382a-382d can be used to specify parameters for the operator specified using operator form 350. FIG. 3 shows two example parameters for the “Build School” operator: a first parameter named “Left_corner_row” using parameter 1 name specification 380a and a second parameter named “Left_corner_col” using parameter 2 name specification 382a. FIG. 3 shows a scroll bar with parameter specifications 380a-380d, 382a-382d to indicate additional specifications are available. For the “Left_corner_row”, or first parameter, FIG. 3 shows the first parameter has a type of “Grid_row” as indicated with parameter 1 type specification 380b, a range of values between “0” and “nrows” as indicated with parameter 1 range specification 380c, and a default value of “0” as indicated with parameter 1 default specification 380d.

FIG. 3 shows that the “Left_corner_col”, or second parameter has a type of “Grid_col” as indicated with parameter 2 type specification 382b, and a range of values between “0” and “ncols” as indicated with parameter 3 range specification 382c. While not visible on FIG. 3, the second parameter can have a default value of “0” as indicated with parameter 2 default specification 382d. In other examples, parameters can be specified using more, fewer, and or different specifications than shown in FIG. 3.

Precondition specifications 384 can be used to specify preconditions, if any, for the operator specified using operator form 350 and can include acceptable role specification 386 and precondition function(s) specification 388. Acceptable role specification 386 can specify one or more roles that can utilize the operator specified using operator form 350 during the problem solution phase. In the example shown in FIG. 3, the “Build School” operator can be utilized by solvers having one or more roles of Problem Admin, City Planner, and Mayor.

In some examples, if no acceptable roles are specified, no solvers can use the operator as no acceptable roles for these solvers have been specified. In some other examples, if no acceptable roles are specified, all solvers, regardless of role, can use the operator. In still other examples, a specific role name, such as “All Roles”, should be specified to permit all roles to use the operator without listing all roles. In yet other examples, roles can be grouped; e.g., a “City Hall” role group can include the “City Planner” and the “Mayor” roles. Then, to specify the acceptable roles in acceptable role specification 386, the list of a “Problem Admin” role and a “City Hall” role group would be equivalent to the list of roles shown in FIG. 3.

Precondition function(s) specification 388 can be used to specify software that enforces the preconditions specified in precondition specification 384. For the “Build School” operator shown in FIG. 3, the “PreBldSchl.jsp” file specified using precondition function(s) specification 388 can include software configured to carry out software operations to ensure that only solvers having the roles listed in acceptable roles specification 386 execute the “Build School” operator during the problem solving phase. The software operations can be coded in one or more computer languages, such as but not limited to, Java, Python, C++, C, and Perl.

Other function specification examples, including specification of more, different, fewer, or no software to be associated with the operator, are possible as well. For example, if no functions are specified in precondition function(s) specification 388, CoSolve system 120 can have software configured to read acceptable roles specification 386 and ensure that only solvers having the role(s) listed in acceptable roles specification 386 execute the “Build School” operator during the problem solving phase.

FIG. 3 also shows parameter map 390 with available map operations 392. Parameter map 390 can be configured to graphically specify operations to be carried out on parameters of the operator. For example, FIG. 3 shows parameter map 390 with parameter identifiers “P1” for the first parameter, “P2” for the second parameter and arrows from P1 and P2 to an encircled ampersand (“&”). The encircled ampersand represents a “combine” operation that takes two or more inputs and generates a combined output, shown in as “Sloc” as the pointed-to name from the arrow leaving the encircled ampersand. Then, parameter map 390 includes text of “if GridMty(Sloc)) BuildSchool else Error(GridNotMty) end”, which indicates that, if the GridMty( ) or “grid empty” function operating on the combined value Sloc of the first and second parameters is true, then the BuildSchool function should be called with inputs of “P1” and “P2”, or the first and second parameters. However, if GridMty( )function operating on Sloc is false, then an Error function with a GridNotMty or “grid not empty” value should be called.

A poser using parameter map 390 can use a graphical input device, such as, but not limited to, a computer mouse or touch screen, to access map operations 392 to enter the above-discussed operations of parameter map. For example, the poser could tap/click on or otherwise access the “Parameter Name” operation to add the parameters “P1” and “P2” to parameter map 390, drag-and-drop or otherwise access the encircled ampersand in map operations 392 and place it in parameter map 390, tap/click on or otherwise access the arrow operator in map operations 392 and draw arrows from P1 and P2 to the encircled ampersand and draw the arrow leaving the encircle ampersand in parameter map 390, tap/click on or otherwise access the “Function/Variable” operation of map operations 392 to add the variable “Sloc” to parameter map 390, and tap/click on or otherwise access the “If Statement” operation of map operations 392 to add the if statement to parameter map 390. Other graphically-based manipulations of operators, parameters, variables, statements, and other computational objects are possible as well.

FIG. 4 illustrates an example solving session display 400. Solving session display 400 is a display for the problem being specified using the forms shown in FIG. 3, showing a problem solving session record with Co Solve during a problem solving session.

Solving session display 400 includes display options 410 and tree display window 412. Display options 410 can include options and operations for tree display 410, including options/operations for logging in/logging out to/from the CoSolve system as a specific entity, options/operations related to problem solving phase files, options/operations for inputting and/or converting a problem, options/operations related to a state, help options/operations, and an option/operation for exiting solving session display 400 with the option to save or discard data on solving session display 400. Options/operations related to problem solving phase files can include opening a new or existing problem formulation and/or problem solving session record as a current problem solving session; e.g. the tree diagram being displayed using tree display window 412, saving a record for the current problem solving session, closing the current problem solving session record with or without saving, and/or printing part or all of the current problem solving session record. Other options/operations related to problem solving phase files are possible as well.

Options/operations for inputting and/or converting a problem can involve inputting one version of multiple versions of a stored problem formulation and/or one solving session record of multiple stored solving session records, and options for utilizing software to take some or all solution activities recorded in one solving session record and applying the some or all solution activities to a different solving session record. In some embodiments, utilizing software to take some or all solution activities recorded in one solving session record and applying the some or all solution activities to a different solving session record can include utilizing software for a problem solving session that engages users in resolving conflicts or ambiguities that arise when old and new problem formulations are not compatible.

Options/operations related to a state can include options/operations for applying an operator to a given state in tree display window 412, for listing operators applicable to a state, for selecting a state, for searching for a state meeting certain criteria - - - e.g., all states for cities with population greater than 100, states for cities having a certain name, states generated by a particular solver, etc., - - - for showing more or less information in tree display window 412 for each state, for outputting colors, images, sounds, and/or other effects related to a state, and/or other state-related options. Help options/operations can include providing information for assisting a problem solver generally with CoSolve system 120, information for assisting with a specific problem formulation, information for providing information, such as annotations, to other problem solvers and/or problem posers, and other information to assist in using CoSolve system 120 to solve and pose problems. Other display options 410 are possible as well.

Tree display window 412 can be configured to use graphics, text, and/or sounds to display information from a solving session record and to allow a solver to begin, continue, and/or finish solving the current problem; e.g., the problem being solved during the current solving session.

When a current problem solving session is initially opened for display by tree display window 412, only the initial state of the problem being solved is displayed. The current solving session permits one or more users and/or entities to utilize a permissible operator to transform a selected state to a new state. In some examples, all users and entities have access to all operators to solve a problem. In other examples, role-based preconditions can apply to one or more operators, thereby enabling or disabling use of the operator for a given entity.

The role(s) of an entity can be determined as part of a login process; e.g., when an presents credentials to CoSolve system 120 to login, CoSolve system 120 can determine one or more roles for the entity to utilize while logged into CoSolve system 120 and accessing the current problem solving session. Note that if the entity changes problem sessions, problem formulations and/or versions of a problem formulation, then the roles available to the entity may change as well; e.g., an entity can have a “Mayor” role in one problem solving session of the city simulation while having a “Police/Fire” role in another problem solving session of the city simulation.

FIG. 4 shows that the current problem displayed by tree display window 412 has an initial state display 420, which includes a state number of 0 and identified as the initial state, a city name of “<none>”, a city size of 10×10, city improvements of a school at grid location (6, 4), a treasury of $100 with taxes of $1/year, and a population of 0. In this example, initial state display 420 shows an initial state as specified in initial state specification 320 of problem formulation form 300, shown in FIG. 3.

FIG. 4 shows that initial state display 420 has two branches—a left branch leading through operator display 422 to state display 424 and a right branch leading through operator display 440 to state display 442. In some embodiments, operator displays are not used.

On the left branch, the initial state was modified using a Build Road operator to generate a state displayed in state display 424. State display 424 shows that:
the state has a state number of 1,
the state was generated by an entity named “Marc the Mark”,
in comparison to the previous state—initial state 0:
   the city has been named “Allaw Allaw”, and
   the population has risen from 0 to 3,
and as a result of the Build Road operation:
   a road from (1,4) to (10,4) has been built,
   the treasury has been reduced from $100 to $80 to build the road, and
   taxes have gone up from $1/year to $11/year to pay maintenance costs.

State display 424 also has a dotted background and includes icon 426 of a smiling face, both of which can be associated with entity “Marc the Mark”. In some embodiments, additional display, color, sound, character/font, and/or other effects for displaying states in tree diagram window 412 can be associated with an entity. In other embodiments, background and other effects associated with an entity can be used in displaying both state displays and operator displays; for example, operator displays 422, 438, 432 and state displays 424, 434 are all shown with a dotted background that can be associated with the entity “Marc the Mark”.

Continuing down the left branch, operator display 428 indicates that a Build Factory operation was applied to State 1, leading to State 2 displayed in state display 430. State display 430 shows that
the state has a state number of 2 and was generated by “Marc the Mark”,
in comparison to previous state 1:
   the population has risen from 3 to 5,
and as a result of the Build Factory operation:
   factories at (1,4) and (9,4) have been built, and
   the treasury has been reduced from $80 to $78 to cover the costs associated with the two factories.

Continuing to the end of the portion of the left branch shown in the tree display window 412, operator display 432 indicates that a Build House operation was applied to State 2, leading to State 3 which was generated by “Marc the Mark” and is partially displayed in state display 434.

Now examining the right branch leading from initial state display 420, the initial state was modified using a Build Road operator to generate a state displayed in state display 442. State display 442 shows that:
the state has a state number of 19,
the state was generated by an entity named “Island Fan”,
in comparison to the previous state—initial state 0:
   the city has been named “Fantastic City”, and
   the population has risen from 0 to 3,
and as a result of the Build Road operation:
   a road from (1,4) to (6,4) has been built,
   the treasury has been reduced from $100 to $88 to build the road, and
   taxes have gone up from $1/year to $7/year to pay maintenance costs.

State display 444 also has a gray background and includes icon 444 of an island with a palm tree, both of which can be associated with entity “Island Fan”. In some embodiments, additional display, color, sound, character/font, and/or other effects for displaying states in tree diagram window 412 can be associated with an entity. In other embodiments, background and other effects associated with an entity can be used in displaying both state displays and operator displays; for example, operator displays 440, 446 and state displays 444, 448 are all shown with a gray background that can be associated with the entity “Island Fan”.

Continuing down the right branch, operator display 446 indicates that a Build House operation was applied to State 19, leading to State 20 displayed in state display 448. State display 448 shows that
the state has a state number of 20 and was generated by “Island Fan”,
in comparison to previous state 19:
   the population has risen from 3 to 10,
and as a result of the Build House operation:
   houses between (6,1) and (6,5) have been built, and
   the treasury has been reduced from $88 to $83 to cover the costs associated with the five houses.

State diagram 448 has been annotated by the “Marc the Mark” entity using annotation 450. Annotation 450 includes a dotted background and smiling face icon associated with the “Marc the Mark” entity, as discussed above. Annotation 450 also includes text of “You might want to add job sources, like factories” as a comment on the state diagram 448. In other examples, an annotation can include other and/or additional types of data, such as other images, video, audio, and/or other information e.g., a binary executable of compiled code. In still other examples, an annotation be responded to, leading to a chain of annotations; e.g. a response from “Island Fan” to annotation 450, such as “We don't have factories on my island” or “Thanks for the advice.” Further other entities can add to the chain of annotations, such as posers, other solvers, and even observers without operator privileges. Many other tree displays, operator displays, state displays, and annotations are possible as well.

### Example Computing Environment

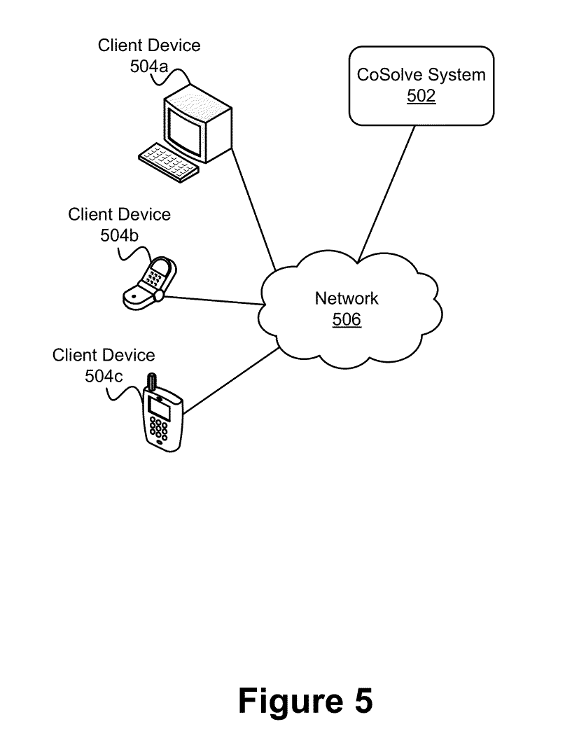

FIG. 5 is a block diagram of an example computing network. Some or all of the above-mentioned techniques disclosed herein, such as but not limited to techniques disclosed as part of and/or being performed by a CoSolve system, can be part of and/or performed by a computing device. For example, FIG. 5 shows CoSolve system 502 configured to communicate, via network 506, with client devices 504a, 504b, and 504bc.

Network 506 may correspond to a LAN, a wide area network (WAN), a corporate intranet, the public Internet, cloud services, or any other type of network configured to provide a communications path between networked computing devices. Network 506 may also correspond to a combination of one or more LANs, WANs, corporate intranets, and/or the public Internet.

Although FIG. 5 only shows three client devices 504a, 504b, 504c, distributed application architectures may serve tens, hundreds, or thousands of client devices. Moreover, client devices 504a, 504b, 504c (or any additional client devices) may be any sort of computing device, such as an ordinary laptop computer, desktop computer, network terminal, wireless communication device (e.g., a cell phone or smart phone), and so on. In some embodiments, client devices 504a, 504b, 504c can be dedicated to problem solving/using CoSolve system 502. In other embodiments, client devices 504a, 504b, 504c can be used as general purpose computers that are configured to perform a number of tasks and need not be dedicated to problem solving.

In still other embodiments, part or all of the functionality of CoSolve system 502 can be incorporated in a client device, such as client device 504a, 504b, and/or 504c.

### Computing Device Architecture

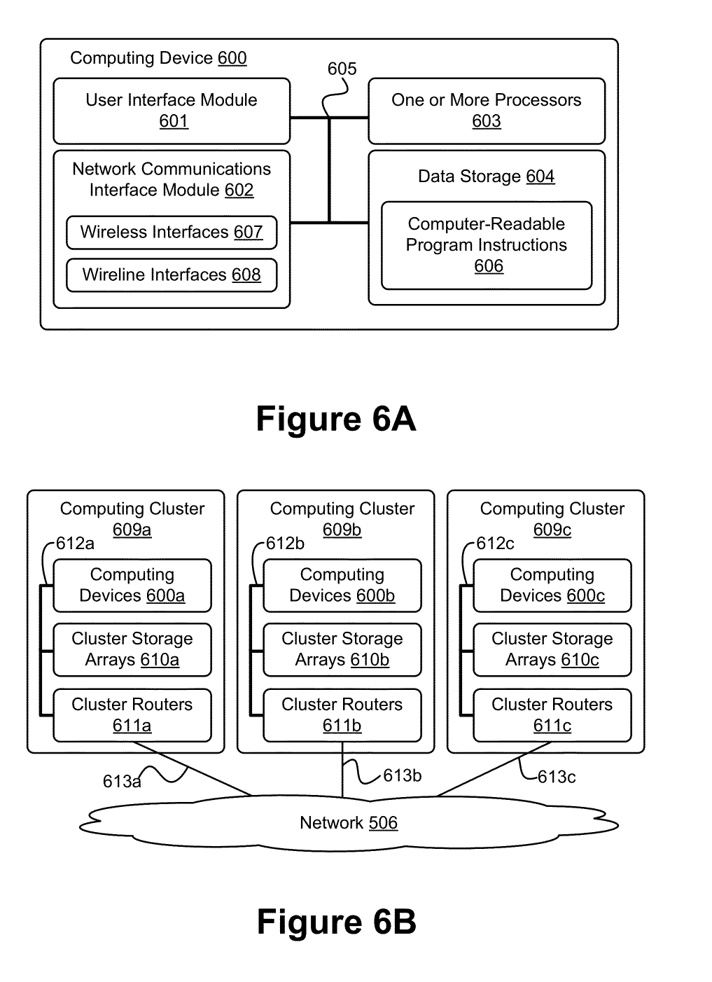

FIG. 6A is a block diagram of an example computing device (e.g., system). In particular, computing device 600 shown in FIG. 6A can be configured to: (i) include components of and/or perform one or more functions or operations of CoSolve device 120, 502, client device 504a, 504b, 504c, network 506, and/or (iii) carry out part or all of any herein-described methods, such as but not limited to method 700. Computing device 600 may include a user interface module 601, a network-communication interface module 602, one or more processors 603, and data storage 604, all of which may be linked together via a system bus, network, or other connection mechanism 605.

User interface module 601 can be operable to send data to and/or receive data from external user input/output devices. For example, user interface module 601 can be configured to send and/or receive data to and/or from user input devices such as a keyboard, a keypad, a touch screen, a computer mouse, a track ball, a joystick, a camera, a voice recognition module, and/or other similar devices. User interface module 601 can also be configured to provide output to user display devices, such as one or more cathode ray tubes (CRT), liquid crystal displays (LCD), light emitting diodes (LEDs), displays using digital light processing (DLP) technology, printers, light bulbs, and/or other similar devices, either now known or later developed. User interface module 601 can also be configured to generate audible output(s), such as a speaker, speaker jack, audio output port, audio output device, earphones, and/or other similar devices.

Network-communications interface module 602 can include one or more wireless interfaces 607 and/or one or more wireline interfaces 608 that are configurable to communicate via a network, such as network 506 shown in FIG. 5. Wireless interfaces 607 can include one or more wireless transmitters, receivers, and/or transceivers, such as a Bluetooth transceiver, a Zigbee transceiver, a Wi-Fi transceiver, a WiMAX transceiver, and/or other similar type of wireless transceiver configurable to communicate via a wireless network. Wireline interfaces 608 can include one or more wireline transmitters, receivers, and/or transceivers, such as an Ethernet transceiver, a Universal Serial Bus (USB) transceiver, or similar transceiver configurable to communicate via a twisted pair, one or more wires, a coaxial cable, a fiber-optic link, or a similar physical connection to a wireline network.

In some embodiments, network communications interface module 602 can be configured to provide reliable, secured, and/or authenticated communications. For each communication described herein, information for ensuring reliable communications (i.e., guaranteed message delivery) can be provided, perhaps as part of a message header and/or footer (e.g., packet/message sequencing information, encapsulation header(s) and/or footer(s), size/time information, and transmission verification information such as CRC and/or parity check values). Communications can be made secure (e.g., be encoded or encrypted) and/or decrypted/decoded using one or more cryptographic protocols and/or algorithms, such as, but not limited to, DES, AES, RSA, Diffie-Hellman, and/or DSA. Other cryptographic protocols and/or algorithms can be used as well or in addition to those listed herein to secure (and then decrypt/decode) communications.

Processors 603 can include one or more general purpose processors and/or one or more special purpose processors (e.g., digital signal processors, application specific integrated circuits, etc.). Processors 603 can be configured to execute computer-readable program instructions 606 contained in data storage 604 and/or other instructions as described herein. Data storage 604 can include one or more computer-readable storage media that can be read and/or accessed by at least one of processors 603. The one or more computer-readable storage media can include volatile and/or non-volatile storage components, such as optical, magnetic, organic or other memory or disc storage, which can be integrated in whole or in part with at least one of processors 603. In some embodiments, data storage 604 can be implemented using a single physical device (e.g., one optical, magnetic, organic or other memory or disc storage unit), while in other embodiments, data storage 604 can be implemented using two or more physical devices.

Data storage 604 can include computer-readable program instructions 606 and perhaps additional data. For example, in some embodiments, data storage 604 can store part or all of data utilized by a CoSolve system; e.g., CoSolve system 120, 502. In some embodiments, data storage 604 can additionally include storage required to perform at least part of the herein-described methods and techniques and/or at least part of the functionality of the herein-described devices and networks.

FIG. 6B depicts a network 506 of computing clusters 609a, 609b, 609c arranged as a cloud-based server system in accordance with an example embodiment. Data and/or software for CoSolve system 120, 502 can be stored on one or more cloud-based devices that store program logic and/or data of cloud-based applications and/or services. In some embodiments, CoSolve system 120, 502 can be a single computing device residing in a single computing center. In other embodiments, CoSolve system 120, 502 can include multiple computing devices in a single computing center, or even multiple computing devices located in multiple computing centers located in diverse geographic locations.

In some embodiments, data and/or software for CoSolve system 120, 502 can be encoded as computer readable information stored in tangible computer readable media (or computer readable storage media) and accessible by client devices 504a, 504b, and 504c, and/or other computing devices. In some embodiments, data and/or software for CoSolve system 120, 502 can be stored on a single disk drive or other tangible storage media, or can be implemented on multiple disk drives or other tangible storage media located at one or more diverse geographic locations.

FIG. 6B depicts a cloud-based server system in accordance with an example embodiment. In FIG. 6B, the operations of CoSolve system 120, 502 can be distributed among three computing clusters 609a, 609b, and 608c. Computing cluster 609a can include one or more computing devices 600a, cluster storage arrays 610a, and cluster routers 611a connected by a local cluster network 612a. Similarly, computing cluster 609b can include one or more computing devices 600b, cluster storage arrays 610b, and cluster routers 611b connected by a local cluster network 612b. Likewise, computing cluster 609c can include one or more computing devices 600c, cluster storage arrays 610c, and cluster routers 611c connected by a local cluster network 612c.

In some embodiments, each of the computing clusters 609a, 609b, and 609c can have an equal number of computing devices, an equal number of cluster storage arrays, and an equal number of cluster routers. In other embodiments, however, each computing cluster can have different numbers of computing devices, different numbers of cluster storage arrays, and different numbers of cluster routers. The number of computing devices, cluster storage arrays, and cluster routers in each computing cluster can depend on the computing task or tasks assigned to each computing cluster.

In computing cluster 609a, for example, computing devices 600a can be configured to perform various computing tasks of CoSolve system 120, 502. In one embodiment, the various functionalities of CoSolve system 120, 502 can be distributed among one or more of computing devices 600a, 600b, and 600c. Computing devices 600b and 600c in computing clusters 609b and 609c can be configured similarly to computing devices 600a in computing cluster 609a. On the other hand, in some embodiments, computing devices 600a, 600b, and 600c can be configured to perform different operations.

In some embodiments, computing tasks and stored data associated with CoSolve system 120, 502 can be distributed across computing devices 600a, 600b, and 600c based at least in part on the processing requirements of CoSolve system 120, 502, the processing capabilities of computing devices 600a, 600b, and 600c, the latency of the network links between the computing devices in each computing cluster and between the computing clusters themselves, and/or other factors that can contribute to the cost, speed, fault-tolerance, resiliency, efficiency, and/or other design goals of the overall system architecture.

The cluster storage arrays 610a, 610b, and 610c of the computing clusters 609a, 609b, and 609c can be data storage arrays that include disk array controllers configured to manage read and write access to groups of hard disk drives. The disk array controllers, alone or in conjunction with their respective computing devices, can also be configured to manage backup or redundant copies of the data stored in the cluster storage arrays to protect against disk drive or other cluster storage array failures and/or network failures that prevent one or more computing devices from accessing one or more cluster storage arrays.

Similar to the manner in which the operations of CoSolve system 120, 502 can be distributed across computing devices 600a, 600b, and 600c of computing clusters 609a, 609b, and 609c, various active portions and/or backup portions of these components can be distributed across cluster storage arrays 610a, 610b, and 610c. For example, some cluster storage arrays can be configured to store one portion of the data and/or software of CoSolve system 120, 502, while other cluster storage arrays can store a separate portion of the data and/or software of CoSolve system 120, 502. Additionally, some cluster storage arrays can be configured to store backup versions of data stored in other cluster storage arrays.

The cluster routers 611a, 611b, and 611c in computing clusters 609a, 609b, and 609c can include networking equipment configured to provide internal and external communications for the computing clusters. For example, the cluster routers 611a in computing cluster 609a can include one or more internet switching and routing devices configured to provide (i) local area network communications between the computing devices 600a and the cluster storage arrays 601a via the local cluster network 612a, and (ii) wide area network communications between the computing cluster 609a and the computing clusters 609b and 609c via the wide area network connection 613a to network 506. Cluster routers 611b and 611c can include network equipment similar to the cluster routers 611a, and cluster routers 611b and 611c can perform similar networking operations for computing clusters 609b and 609b that cluster routers 611a perform for computing cluster 609a.

In some embodiments, the configuration of the cluster routers 611a, 611b, and 611c can be based at least in part on the data communication requirements of the computing devices and cluster storage arrays, the data communications capabilities of the network equipment in the cluster routers 611a, 611b, and 611c, the latency and throughput of local networks 612a, 612b, 612c, the latency, throughput, and cost of wide area network links 613a, 613b, and 613c, and/or other factors that can contribute to the cost, speed, fault-tolerance, resiliency, efficiency and/or other design goals of the moderation system architecture.

### Example Methods of Operation

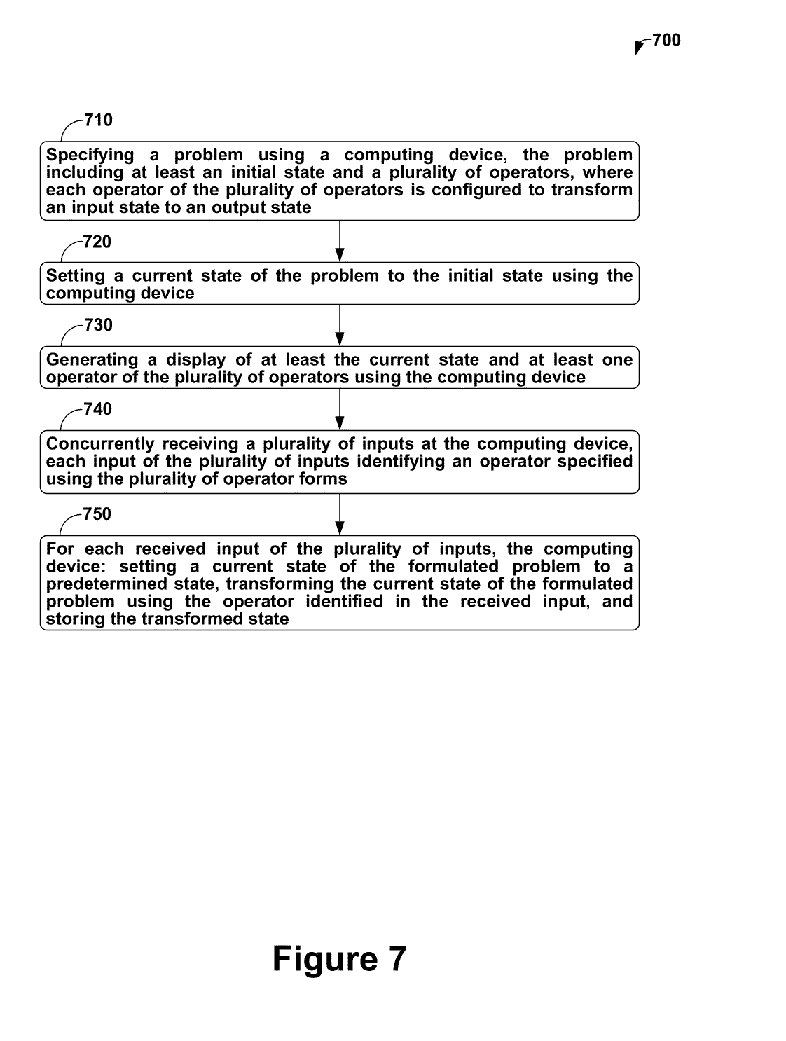

FIG. 7 is a flow chart of an example method 700. Method 700 can begin at block 710, where a problem can be specified using a computing device, such as computing device 600 described above. The problem can include at least an initial state and a plurality of operators. Each operator of the plurality of operators can configured to transform an input state to an output state.

At block 720, the computing device can set a current state of the problem to the initial state.

At block 730, the computing device can generate a display of at least the current state and at least one operator of the plurality of operators.

At block 740, the computing device can concurrently receive a plurality of inputs. Each input of the plurality of inputs can identify an operator specified using the plurality of operator forms.

At block 750, the computing device can, for each received input of the plurality of inputs: set a current state of the formulated problem to a predetermined state, transform the current state of the formulated problem to a transformed state of the formulated problem using the operator specified in the received input, and store the transformed state.

In some embodiments, method 700 can further include generating a display including information about the current state and at least one transformed state transformed by at least one operator specified in the plurality of inputs.

In selected embodiments, the plurality of inputs are provided by at least a first entity and a second entity, where the first entity differs from the second entity. In particular embodiments, method 700 can include generating a second display of at least the initial state, the transformed state, and the second transformed state, where the display of the transformed state indicates an association with the first entity, and where the display of the second transformed state indicates an association with the second entity. In other particular embodiments, at least one of the first entity or the second entity can include an agent, where the agent can include software executing on the computing device. In more particular embodiments, the first entity can collaborates with the second entity using the agent, where the first entity collaborates with the second entity, and where the first entity includes a human user and the second entity includes a computer agent.

In even other particular embodiments, method 700 can include generating an annotation related to solving the problem.

### CONCLUSION

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural or singular number, respectively. Additionally, the words “herein,” “above” and “below” and words of similar import, when used in this application, shall refer to this application as a whole and not to any particular portions of this application.

The above description provides specific details for a thorough understanding of, and enabling description for, embodiments of the disclosure. However, one skilled in the art will understand that the disclosure may be practiced without these details. In other instances, well-known structures and functions have not been shown or described in detail to avoid unnecessarily obscuring the description of the embodiments of the disclosure. The description of embodiments of the disclosure is not intended to be exhaustive or to limit the disclosure to the precise form disclosed. While specific embodiments of, and examples for, the disclosure are described herein for illustrative purposes, various equivalent modifications are possible within the scope of the disclosure, as those skilled in the relevant art will recognize.

All of the references cited herein are incorporated by reference. Aspects of the disclosure can be modified, if necessary, to employ the systems, functions and concepts of the above references and application to provide yet further embodiments of the disclosure. These and other changes can be made to the disclosure in light of the detailed description.

Specific elements of any of the foregoing embodiments can be combined or substituted for elements in other embodiments. Furthermore, while advantages associated with certain embodiments of the disclosure have been described in the context of these embodiments, other embodiments may also exhibit such advantages, and not all embodiments need necessarily exhibit such advantages to fall within the scope of the disclosure.

The above detailed description describes various features and functions of the disclosed systems, devices, and methods with reference to the accompanying figures. In the figures, similar symbols typically identify similar components, unless context dictates otherwise. The illustrative embodiments described in the detailed description, figures, and claims are not meant to be limiting. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the ladder diagrams, scenarios, and flow charts in the figures and as discussed herein, each block and/or communication may represent a processing of information and/or a transmission of information in accordance with example embodiments. Alternative embodiments are included within the scope of these example embodiments. In these alternative embodiments, for example, functions described as blocks, transmissions, communications, requests, responses, and/or messages may be executed out of order from that shown or discussed, including substantially concurrent or in reverse order, depending on the functionality involved. Further, more or fewer blocks and/or functions may be used with any of the ladder diagrams, scenarios, and flow charts discussed herein, and these ladder diagrams, scenarios, and flow charts may be combined with one another, in part or in whole.

A block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical functions or actions in the method or technique. The program code and/or related data may be stored on any type of computer readable medium such as a storage device including a disk or hard drive or other storage medium.

The computer readable medium may also include non-transitory computer readable media such as computer-readable media that stores data for short periods of time like register memory, processor cache, and random access memory (RAM). The computer readable media may also include non-transitory computer readable media that stores program code and/or data for longer periods of time, such as secondary or persistent long term storage, like read only memory (ROM), optical or magnetic disks, compact-disc read only memory (CD-ROM), for example. The computer readable media may also be any other volatile or non-volatile storage systems. A computer readable medium may be considered a computer readable storage medium, for example, or a tangible storage device.

Moreover, a block that represents one or more information transmissions may correspond to information transmissions between software and/or hardware modules in the same physical device. However, other information transmissions may be between software modules and/or hardware modules in different physical devices.

Numerous modifications and variations of the present disclosure are possible in light of the above teachings.

1-8. (canceled)

9. A system for problem solving, comprising:
means for creating an instance of a problem, wherein the problem is formulated as a structure comprising (i) a specification for creating an initial state and (ii) a specification for each of a plurality of operators;
means for realizing the initial state of the problem using the specification for creating the initial state; and
means for applying an operator of the plurality of operators to the initial state during a problem-solving session, wherein the problem-solving session can be accessed by a plurality of entities concurrently.

10. The system of claim 9, wherein the means for applying the operator of the plurality of operators generates an intermediate state.

11. The system of claim 10, wherein the means for applying the operator of the plurality of operators comprises means for applying the operator of the plurality of operators to the intermediate state.

12. The system of claim 9, further comprising:
means for associating one or more entities during the problem-solving session.

13. The system of claim 12, further comprising:
means for associating a role of a plurality of roles to each of the one or more entities, wherein each role of the plurality of roles is associated with zero or more operators of the plurality of operators.

14. The system of claim 13, wherein means for associating a role comprise means for associating a zero-operator role, wherein the zero-operator role is associated with zero operators, and wherein an entity associated with the zero-operator role can solely generate annotations, review a session history, and comment on the session history.

15. The system of claim 13, wherein the plurality of operators comprises a preconditioned operator, wherein the specification of the preconditioned operator comprises a precondition, the precondition configured to specify one or more permitted roles, and wherein the means for applying the operator comprise means for applying the preconditioned operator only by an entity associated with a permitted role of the one or more permitted roles specified by the precondition of the preconditioned operator.

16. The system of claim 9, further comprising:
means to display a diagram of a history for solving the problem.

17. The system of claim 16, wherein the diagram comprises a tree diagram.

18. The system of claim 17, further comprising:
means to create an annotation; and
means to affix the annotation to a node of the tree diagram.

19. The system of claim 9, further comprising:
means to distribute a computation applying at least one operator of the plurality of operators.

20. A system for computational problem solving, comprising:
means for specifying a problem solving task within a problem-solving session as a tree of states, wherein the problem solving task comprises a sub-problem of and/or information processing within a problem being addressed during the problem-solving session, wherein the problem solving task includes a task-focus state; and wherein the tree of states can be concurrently accessed by each entity of a plurality of entities, and
means for performing the problem solving task comprising at least one means selected from the group consisting of:
means for generating the tree of states by applying one or more operators to the task-focus state and/or at least one state generated by applying the one or more operators, and
means for evaluating each state in the tree of states using a computational function during the problem-solving session.

21. The system of claim 21, further comprising:
means for displaying the results of the problem solving task, wherein the results are not recorded permanently.

22. The system of claim 20, further comprising:
means for interrupting the system;
means for canceling the problem solving task after interrupting the system; and
means for continuing the problem solving task after interrupting the system.

23. The system of claim 20, wherein the means for generating the tree of states comprise means for specifying an operator;
wherein the system further comprises means for associating a parameter generator with the operator; and
wherein the parameter generator is configured to generate one or more proper inputs to the operator.

24. The system of claim 20, wherein the problem solving task further includes a specification of an amount of resources available, and wherein means for generating the tree of states comprise means for generating the tree of states while consuming no more than the amount of resources available.

25-26. (canceled)

27. A method, comprising:
specifying a problem using a computing device, the problem comprising at least an initial state and a plurality of operators, wherein each operator of the plurality of operators is configured to transform an input state to an output state;
setting a current state of the problem to the initial state using the computing device;
generating a display of at least the current state and at least one operator of the plurality of operators using the computing device;
concurrently receiving a plurality of inputs at the computing device, each input of the plurality of inputs identifying an operator specified using the plurality of operator forms; and
for each received input of the plurality of inputs, the computing device:
setting a current state of the formulated problem to a predetermined state,
transforming the current state of the formulated problem to a transformed state of the formulated problem using the operator specified in the received input, and
storing the transformed state.

28. The method of claim 27, further comprising:
generating a display comprising information about the current state and at least one transformed state transformed by at least one operator specified in the plurality of inputs.

29. The method of claim 27, wherein the plurality of inputs are provided by at least a first entity and a second entity, with the first entity different from the second entity.

30. The method of claim 29, further comprising:
generating a second display of at least the initial state, the transformed state, and the second transformed state, wherein the display of the transformed state indicates an association with the first entity, and wherein the display of the second transformed state indicates an association with the second entity.

31. The method of claim 29, wherein at least one of the first entity or the second entity comprises an agent, and wherein the agent comprises software executing on the computing device.

32. The method of claim 31, wherein the first entity collaborates with the second entity, and wherein the first entity comprises a human user and the second entity comprises a computer agent.

33. The method of claim 27, further comprising:
generating an annotation related to solving the problem.

34. An article of manufacture including a computer-readable storage medium having stored thereon program instructions that, upon execution by a computing device, cause the computing device to perform operations comprising:
specifying a problem, wherein the problem comprises at least an initial state and a plurality of operators, and wherein each operator of the plurality of operators is configured to transform an input state to an output state;
setting a current state of the problem to the initial state;
generating a display of at least the current state and at least one operator of the plurality of operators;
concurrently receiving a plurality of inputs, each input of the plurality of inputs identifying an operator specified using the plurality of operator forms; and
for each received input of the plurality of inputs:
setting a current state of the formulated problem to a predetermined state,
transforming the current state of the formulated problem to a transformed state of the formulated problem using the operator identified in the received input, and
storing the transformed state.

35. The article of manufacture of claim 34, the operations further comprising:
generating a display comprising information about the current state and at least one transformed state transformed by at least one operator specified in the plurality of inputs.

36. The article of manufacture of claim 34, wherein the plurality of inputs are provided by at least a first entity and a second entity, with the first entity different from the second entity.

37. The article of manufacture of claim 36, the operations further comprising:
generating a second display of at least the initial state, the transformed state, and the second transformed state, wherein the display of the transformed state indicates an association with the first entity, and wherein the display of the second transformed state indicates an association with the second entity.

38. The article of manufacture of claim 36, wherein at least one of the first entity or the second entity comprises an agent, and wherein the agent comprises software.

39. The article of manufacture of claim 38, wherein the first entity collaborates with the second entity using the agent.

40. The article of manufacture of claim 34, the operations further comprising:
generating an annotation related to solving the problem.
